(19) United States
(12) Patent Application Publication
(10) Pub. No.: US 2005/0028653 A1
(43) Pub. Date: Feb. 10, 2005

(54) Hand tool having an adjustable holding portion

(76) Inventor: Chih-Ching Hsien, Taichung (TW)

Correspondence Address: Chih-Ching Hsien, 58, MA YUAN WEST ST., TAICHUNG, TW

(21) Appl. No.: 10/638,935

(22) Filed: Aug. 8, 2003

(51) Int. Cl. B25B 7/00

(52) U.S. Cl. 81/427.5

(57) ABSTRACT

A hand tool includes a head portion, and a handle portion rotatably mounted on the head portion. Thus, the handle portion can be rotated relative to the head portion to the optimum angle, so that the user' one hand can hold the handle portion smoothly and comfortably, thereby facilitating the user operating the hand tool.

### BACKGROUND OF THE INVENTION

1. Field of the Invention

The present invention relates to a hand tool, such as a pair of pliers, a ratchet wrench, a hammer or the like, and more particularly to a hand tool having an adjustable holding portion that can be adjusted in a rotation manner.

2. Description of the Related Art

A conventional hand tool, such as a pair of pliers, comprises a head portion having two jaw portions pivotally connected with each other by a pivot pin, and a handle portion mounted on the head portion and having two grips each integrally formed on a respective one of the two jaw portions of the head portion.

However, the handle portion is integrally formed on the head portion, so that the relative angle between the handle portion and the head portion is fixed and cannot be adjusted, thereby decreasing the driving force of the conventional hand tool. In addition, the relative angle between the handle portion and the head portion is fixed and cannot be adjusted, so that the user' one hand cannot hold the handle portion smoothly and comfortably, thereby causing inconvenience to the user when operating the hand tool.

### SUMMARY OF THE INVENTION

The primary objective of the present invention is to provide a hand tool having a holding portion that can be adjusted in a rotation manner.

Another objective of the present invention is to provide a hand tool, wherein the handle portion can be slightly rotated relative to the head portion to the optimum angle, so that the user' one hand can hold the handle portion smoothly and comfortably, thereby facilitating the user operating the hand tool.

A further objective of the present invention is to provide a hand tool, wherein the handle portion can be slightly rotated relative to the head portion to the optimum angle, thereby enhancing the driving force of the hand tool.

A further objective of the present invention is to provide a hand tool, wherein the handle portion can be rotated relative to the head portion through 180 degrees, so that the inner curved face of the handle portion faces outward, so that the user' one hand can hold the handle portion easily and conveniently, thereby achieving the optimum driving effect.

A further objective of the present invention is to provide a hand tool, wherein the protrusion of the inner curved face of the handle portion can provide an anti-skid effect, thereby preventing the user's hand from slipping from the handle portion.

In accordance with the present invention, there is provided a hand tool, comprising:
a head portion; and
a handle portion rotatably mounted on the head portion.

In practice, the head portion has an end having in inside formed with an axial hole, and the handle portion has an end rotatably mounted in the axial hole of the head portion.

In addition, the end of the head portion has a periphery formed with a transverse hole communicating with the axial hole, the end of the handle portion has a periphery formed with an annular groove aligning with the transverse hole of the head portion, and the hand tool further comprises a positioning pin extended through the transverse hole of the head portion and locked in the annular groove of the handle portion, so that the handle portion is rotatably mounted on the head portion.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a hand tool in accordance with the preferred embodiment of the present invention;

FIG. 2 is a perspective assembly view of the hand tool as shown in FIG. 1;

FIG. 3 is a front plan partially cross-sectional view of the hand tool as shown in FIG. 2;

FIG. 4 is a schematic operational view of the hand tool as shown in FIG. 3 in use;

FIG. 5 is a schematic operational view of the hand tool as shown in FIG. 3 in use;

FIG. 6 is a perspective assembly view of a hand tool in accordance with another embodiment of the present invention;

FIG. 7 is a schematic operational view of the hand tool as shown in FIG. 6 in use; and

FIG. 8 is a side plan partially cross-sectional view of a hand tool in accordance with another embodiment of the present invention.

### DETAILED DESCRIPTION OF THE INVENTION

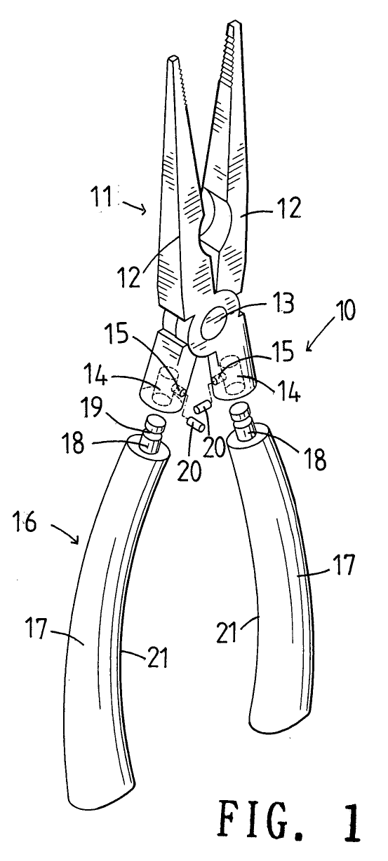

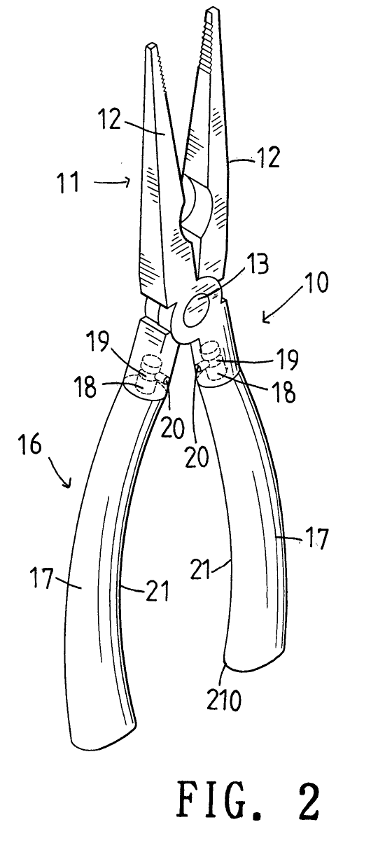

Referring to the drawings and initially to FIGS. 1-3, a hand tool 10, such as a pair of pliers in accordance with the preferred embodiment of the present invention comprises a head portion 11, and a handle portion 16 rotatably mounted on the head portion 11.

The head portion 11 has two jaw portions 12 pivotally connected with each other by a pivot pin 13. Each of the two jaw portions 12 of the head portion 11 has an end having in inside formed with an axial hole 14 and having a periphery formed with a transverse hole 15 communicating with the axial hole 14. Preferably, the axial hole 14 of each of the two jaw portions 12 of the head portion 11 has a circular shape.

The handle portion 16 has two holding grips 17 each having an end formed with a protruding insertion portion 18 rotatably mounted in the axial hole 14 of a respective one of the two jaw portions 12 of the head portion 11. Preferably, the insertion portion 18 of each of the two holding grips 17 of the handle portion 16 has a circular shape. In addition, the insertion portion 18 of each of the two holding grips 17 of the handle portion 16 has a periphery formed with an annular groove 19 aligning with the transverse hole 15 of a respective one of the two jaw portions 12 of the head portion 11. In addition, each of the two holding grips 17 of the handle portion 16 has an inner curved face 21 having a distal end formed with a protrusion 210.

The hand tool 10 further comprises two positioning pins 20 each extended through the transverse hole 15 of a respective one of the two jaw portions 12 of the head portion 11 and each locked in the annular groove 19 of the insertion portion 18 of a respective one of the two holding grips 17 of the handle portion 16, so that each of the two holding grips 17 of the handle portion 16 is rotatably mounted on a respective one of the two jaw portions 12 of the head portion 11, and the handle portion 16 is rotatably mounted on the head portion 11.

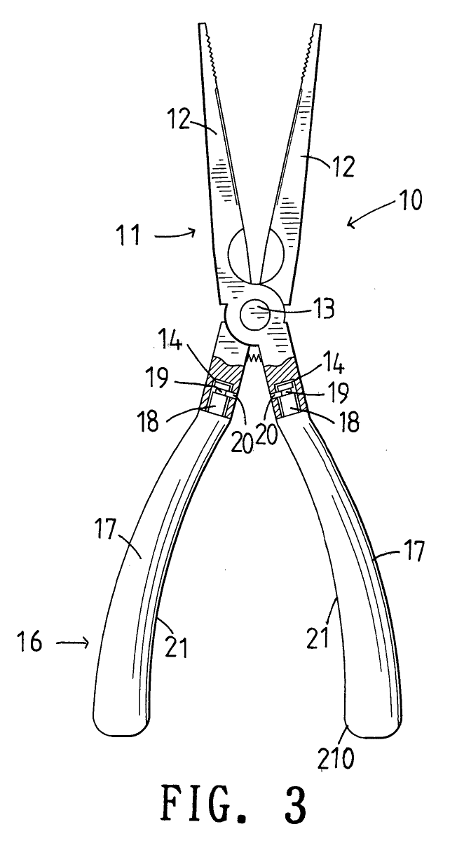

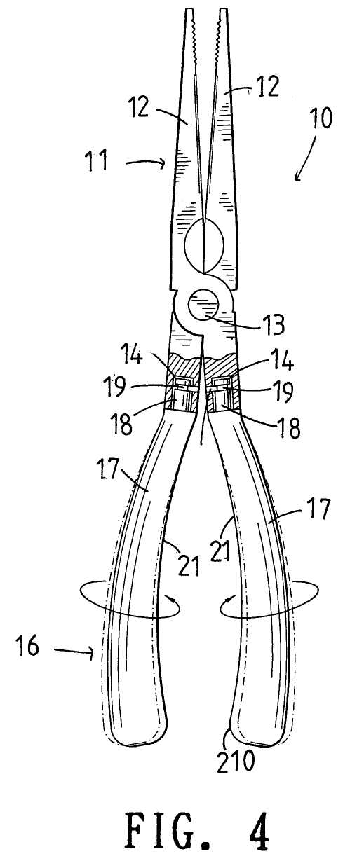

In operation, referring to FIGS. 3 and 4, when the user' one hand holds the handle portion 16, the handle portion 16 can be slightly rotated relative to the head portion 11 to the optimum angle as shown in FIG. 4, so that the user' one hand can hold the handle portion 16 smoothly and comfortably, thereby facilitating the user operating the hand tool 10. In addition, the handle portion 16 can be slightly rotated relative to the head portion 11 to the optimum angle, thereby enhancing the driving force of the hand tool 10.

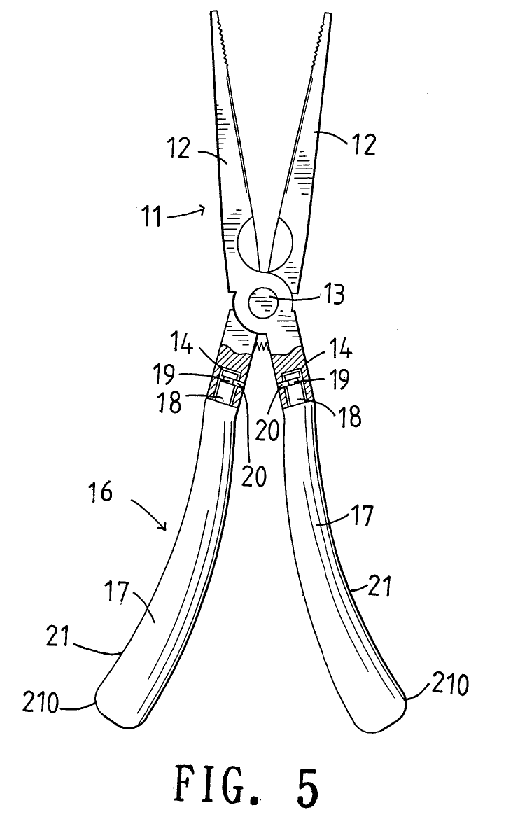

Referring to FIG. 5, the handle portion 16 can be rotated relative to the head portion 11 through 180 degrees, so that the inner curved face 21 of each of the two holding grips 17 of the handle portion 16 faces outward, so that the user' one hand can hold the handle portion 16 easily and conveniently, thereby achieving the optimum driving effect. In addition, the protrusion 210 of the inner curved face 21 of each of the two holding grips 17 of the handle portion 16 can provide an anti-skid effect, thereby preventing the user's hand from slipping from the handle portion 16.

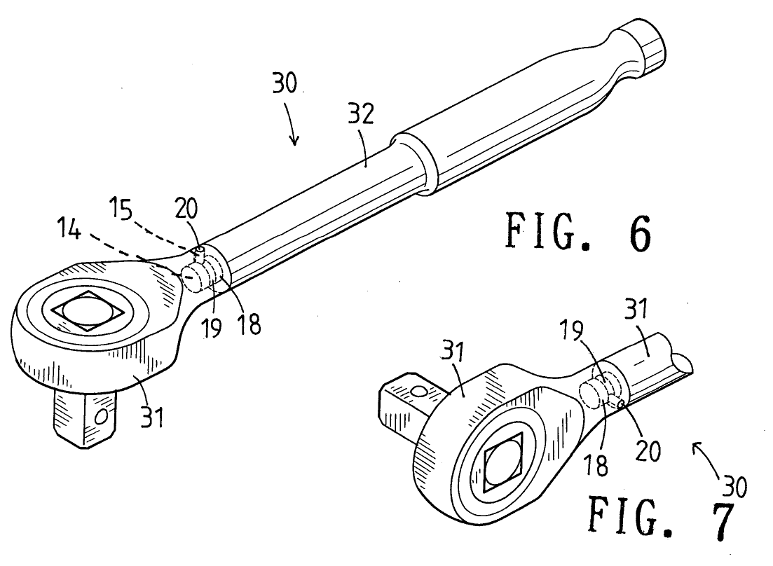

Referring to FIGS. 6 and 7, the hand tool is a ratchet wrench 30 comprising a head portion 31, and a handle portion 32 rotatably mounted on the head portion 11. The head portion 31 has an end having in inside formed with an axial hole 14 and having a periphery formed with a transverse hole 15 communicating with the axial hole 14. The handle portion 32 has an end formed with a protruding insertion portion 18 rotatably mounted in the axial hole 14 of the head portion 31. Preferably, the insertion portion 18 of the handle portion 32 has a periphery formed with an annular groove 19 aligning with the transverse hole 15 of the head portion 31. The ratchet wrench 30 further comprises a positioning pin 20 extended through the transverse hole 15 of the head portion 31 and locked in the annular groove 19 of the insertion portion 18 of the handle portion 32, so that the handle portion 32 is rotatably mounted on the head portion 31.

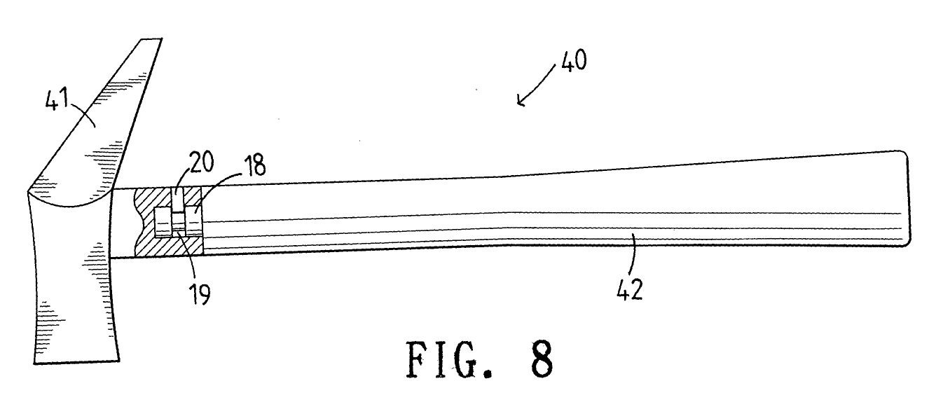

Referring to FIG. 8, the hand tool is a hammer 40 comprising a head portion 41, and a handle portion 42 rotatably mounted on the head portion 41.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A hand tool, comprising:
a head portion; and
a handle portion rotatably mounted on the head portion.

2. The hand tool in accordance with claim 1, wherein the head portion has an end having in inside formed with an axial hole, and the handle portion has an end rotatably mounted in the axial hole of the head portion.

3. The hand tool in accordance with claim 2, wherein the end of the head portion has a periphery formed with a transverse hole communicating with the axial hole, the end of the handle portion has a periphery formed with an annular groove aligning with the transverse hole of the head portion, and the hand tool further comprises a positioning pin extended through the transverse hole of the head portion and locked in the annular groove of the handle portion, so that the handle portion is rotatably mounted on the head portion.

4. The hand tool in accordance with claim 3, wherein the end of the handle portion is formed with a protruding insertion portion rotatably mounted in the axial hole of the head portion, and the annular groove is formed in the insertion portion of the handle portion.

5. The hand tool in accordance with claim 4, wherein the insertion portion of the handle portion has a circular shape.

6. The hand tool in accordance with claim 2, wherein the axial hole of the head portion has a circular shape.

7. The hand tool in accordance with claim 1, wherein the handle portion has an inner curved face having a distal end formed with a protrusion.

8. The hand tool in accordance with claim 7, wherein the inner curved face of the handle portion has a distal end formed with a protrusion.

9. The hand tool in accordance with claim 1, wherein the hand tool is a pair of pliers.

10. The hand tool in accordance with claim 1, wherein the hand tool is a ratchet wrench.

11. The hand tool in accordance with claim 1, wherein the hand tool is a hammer.
